(19) United States
(12) Patent Application Publication
(10) Pub. No.: US 2020/0334165 A1
(43) Pub. Date: Oct. 22, 2020

(54) METHODS AND SYSTEMS FOR MANAGING STORAGE DEVICE SPACE

(71) Applicant: NETAPP, INC., Sunnyvale, CA (US)

(72) Inventors: Sagi Manole, Petah Takva (IL); Boaz Harrosh, Tel Aviv (IL); Amit Golander, Tel Aviv (IL)

(73) Assignee: NETAPP, INC., Sunnyvale, CA (US)

(21) Appl. No.: 16/386,884

(22) Filed: Apr. 17, 2019

(51) Int. Cl. G06F 12/10

(52) U.S. Cl. CPC G06F 12/10; G06F 2212/657

(57) ABSTRACT

Methods and systems for a storage system are provided. One method includes updating a device mapping array upon addition of a second storage device for a computing system having at least a first storage device for storing information. The device mapping array includes a plurality of entries, each entry pointing to a starting address of the first and second storage device; and a number of the plurality of entries are based on a total storage capacity of the first and the second storage device. The method further includes mapping free blocks of a logical address space for the first and the second storage device to a plurality of units of an allocator address space; and assigning the mapped plurality of units of the allocator address space to a queue associated with a processor of the computing system.

### TECHNICAL FIELD

The present disclosure relates to storage systems, and more particularly, to computing technology for efficiently managing and allocating storage device storage space.

### BACKGROUND

Various forms of storage systems are used today. These forms include direct attached storage (DAS) network attached storage (NAS) systems, storage area networks (SANs), and others. Network storage systems are commonly used for a variety of purposes, such as providing multiple users with access to shared data, backing up data and others.

A networked storage system typically includes at least one computing system executing a storage operating system with a file system for storing and retrieving data on behalf of one or more client computing systems (“clients”). The file system stores and manages shared data containers in a set of mass storage devices.

Non-volatile or persistent memory (PM) technology implemented through a nonvolatile media attached to a central processing unit (CPU) of a computing system, may also be used to store data. PM is characterized by low RAM-like latencies, so it faster than the flash-based solid state device and hard drives. PM-aware file systems (e.g. EXT4-DAX) are used to directly access the PM for storing and retrieving data.

In conventional system, storage space is allocated using rigid mathematical concepts. For example, striping techniques commonly used to store consecutive data segments on different storage devices are inflexible. When storage consumption grows, it is hard to leverage the performance and availability of newly added storage devices to computing systems with existing storage devices. Continuous efforts are being made to develop computing technology for efficiently allocating and using storage space at storage devices.

### BRIEF DESCRIPTION OF THE DRAWINGS

The foregoing features and other features will now be described with reference to the drawings of the various aspects. In the drawings, the same components have the same reference numerals. The illustrated aspects are intended to illustrate, but not to limit the present disclosure. The drawings include the following Figures:

FIG. 1A shows an example of a device mapping array, according to one aspect of the present disclosure;

FIG. 1B shows an example of using the device mapping array of FIG. 1A for three storage devices, according to one aspect of the present disclosure;

FIG. 1C shows an example of using the device mapping array of FIG. 1A for four storage devices, according to one aspect of the present disclosure;

FIG. 1D shows an example of using the device mapping array of FIG. 1A for four storage devices with storage capacity of the fourth device being different from the fourth storage device of FIG. 1C, according to one aspect of the present disclosure;

FIG. 1E shows an example of using an allocator address space, according to one aspect of the present disclosure;

FIG. 1F shows an example of using an allocator address space for a single processor system, according to one aspect of the present disclosure;

FIG. 1G shows a process flow for configuring the various address spaces of the present disclosure;

FIG. 1H shows a process for allocating storage space, according to one aspect of the present disclosure;

FIG. 1I shows an example of an operating environment for implementing the various aspects of the present disclosure;

FIG. 2A shows an example of a computing system using a persistent memory based file system, according to one aspect of the present disclosure;

FIG. 2B shows an example of a storage system node of a networked storage system, used according to one aspect of the present disclosure; and

FIG. 3 shows an example of a storage operating system, used according to one aspect of the present disclosure.

### DETAILED DESCRIPTION

As preliminary note, the terms “component”, “module”, “system,” and the like as used herein are intended to refer to a computer-related entity, either software-executing general purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory, computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device type, in accordance with the claimed subject matter.

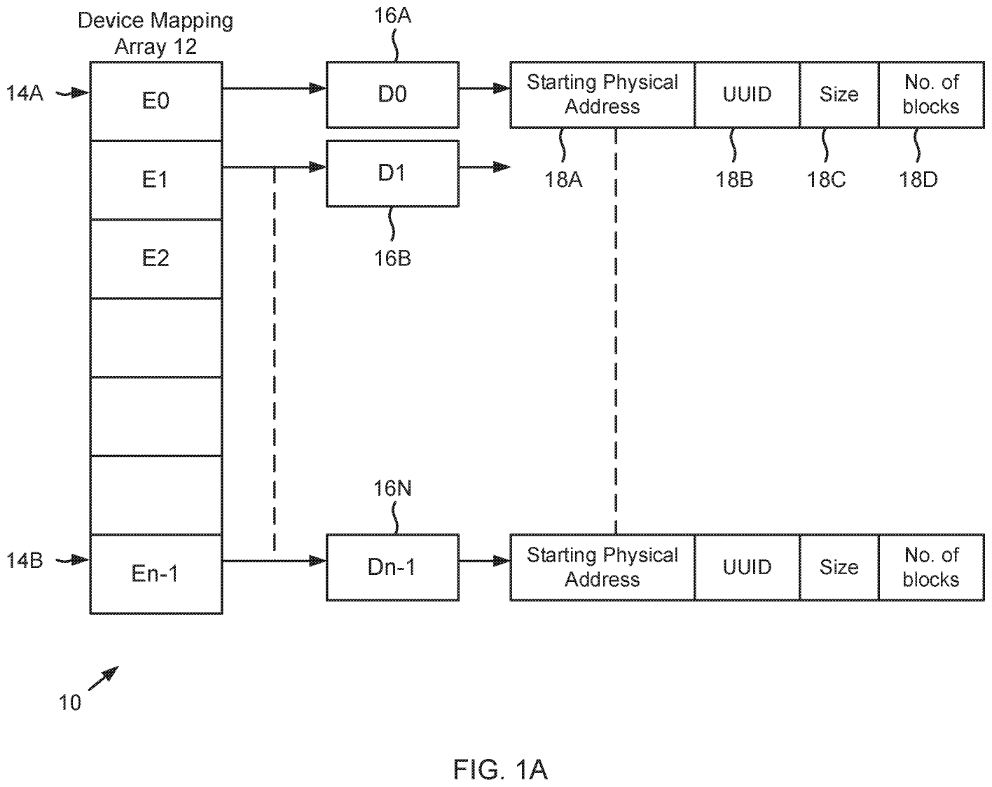

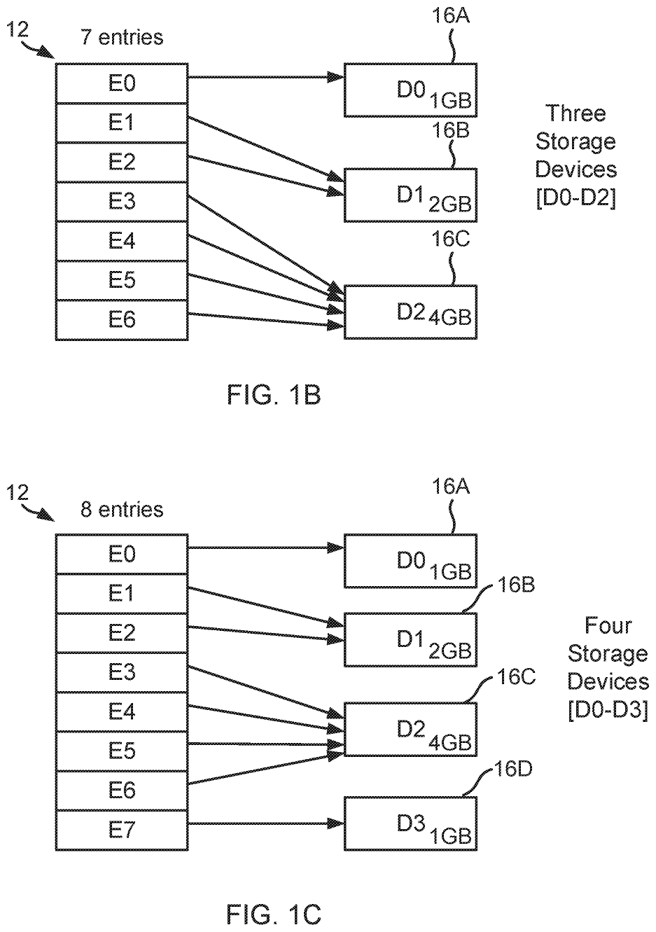

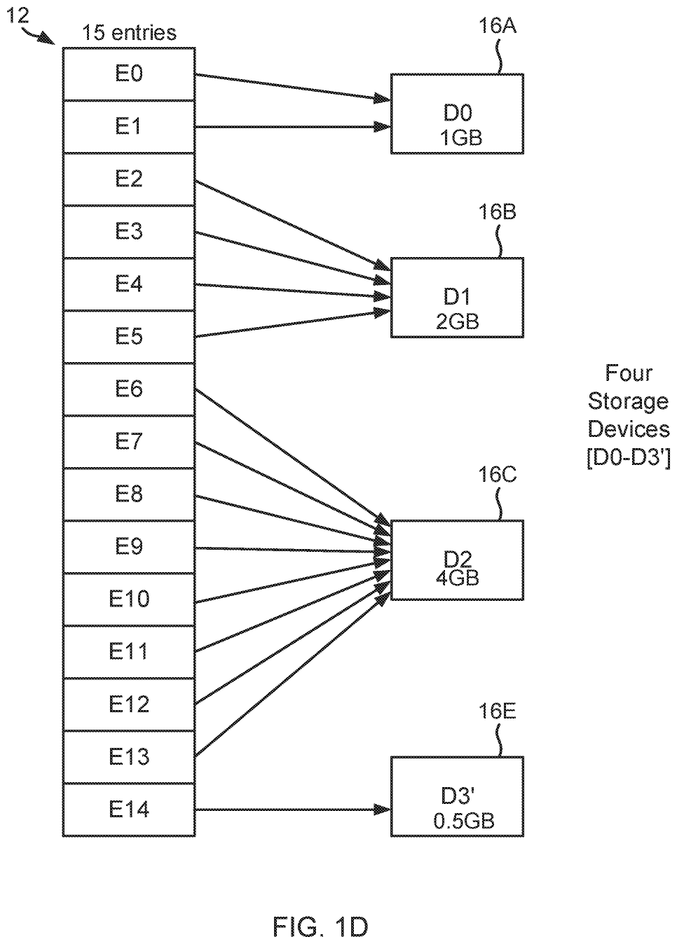

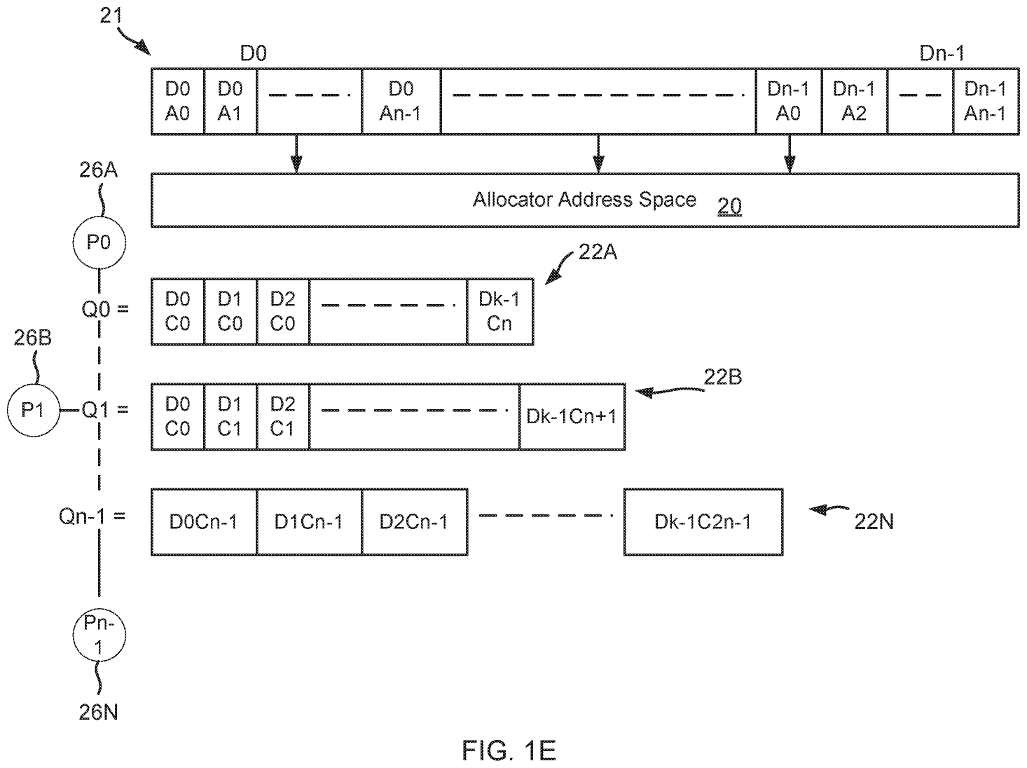

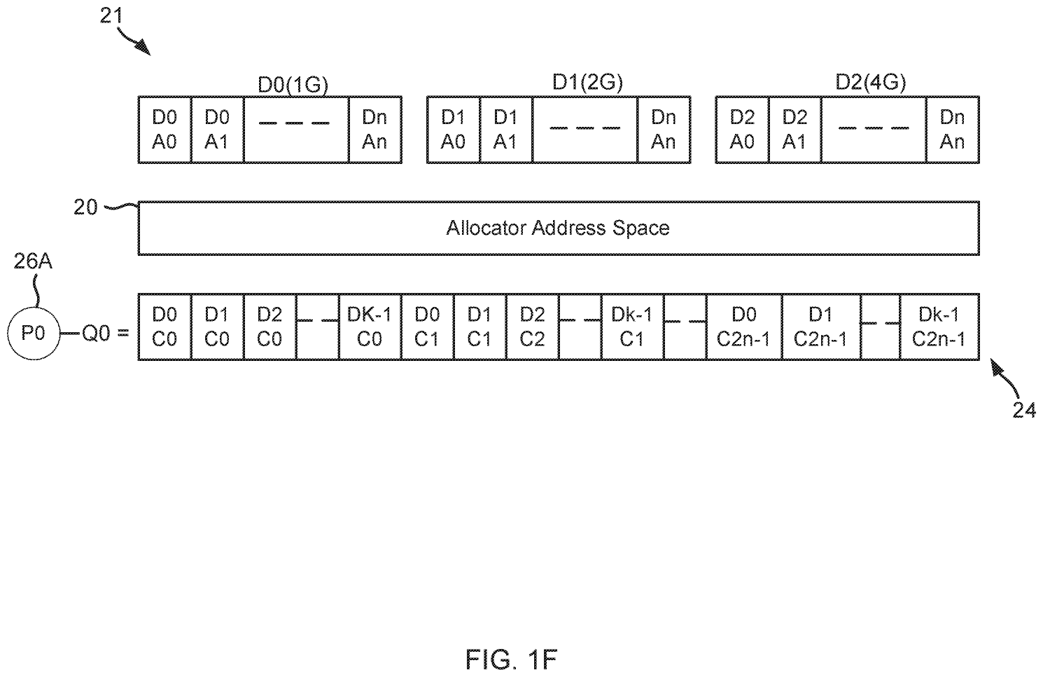

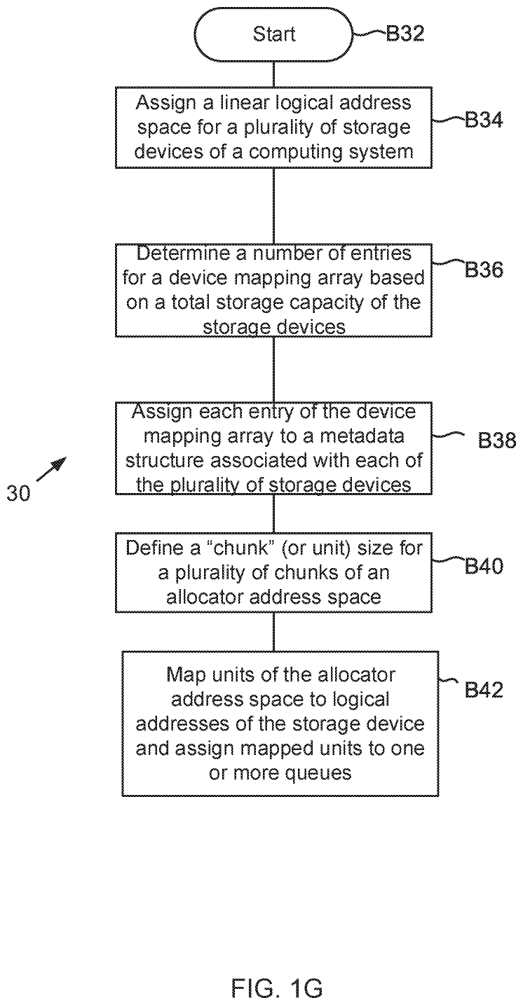

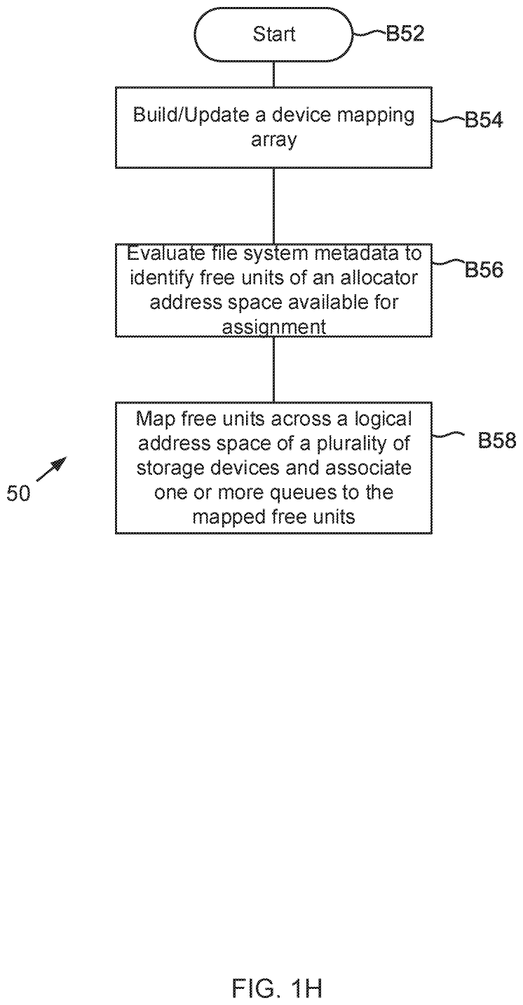

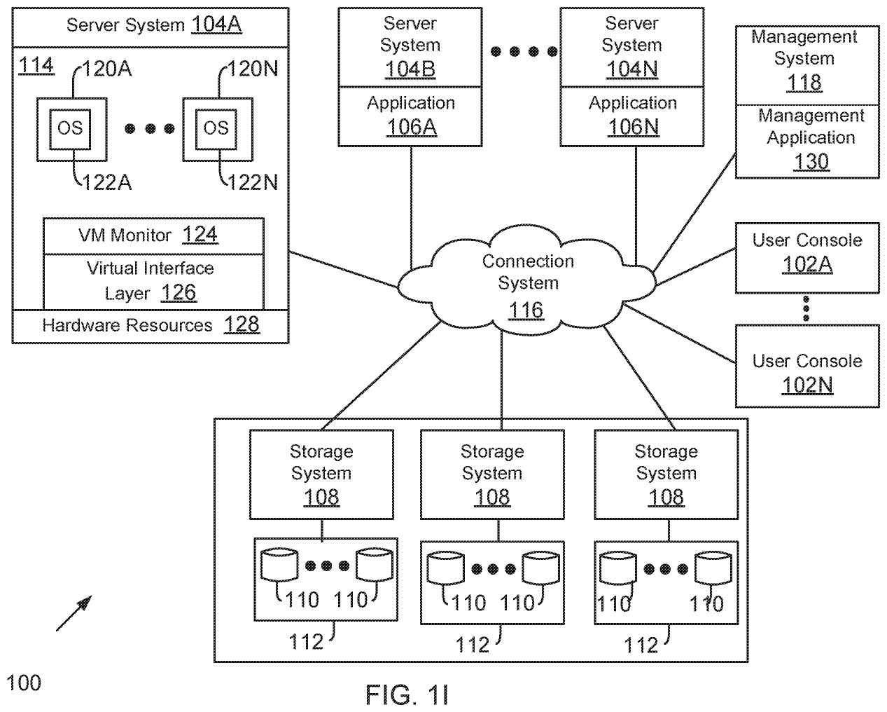

FIG. 1A shows a system 10 with a device mapping array (may also be referred to as “array”) 12 having a plurality of entries (shown as E0 to En−1) 14A-14N associated with a plurality of storage devices, where each storage device has its own linear logical address space. The array 12 may be used to map logical addresses of a storage device to physical addresses. As an example, the number of entries in array 12 can be determined by a quotient of a total storage capacity of the storage devices and a greatest common denominator of the storage capacity of each device. For example, if there are three storage devices, of sizes 1 GB or 1 G (gigabytes), 2 GB, and 4 GB, then the number of entries in array 12 are determined by: (1+2+4)/1=7, where 1 is the common denominator and 7 GB is the total capacity.

Each array 12 entry points to a metadata structure associated with each storage device, shown as D0 16A, D1 16B and Dn−1 16N, where D0, D1 and Dn−1 indicate a storage device. The metadata structure 16A-16N includes a plurality of fields, an example of which is shown as fields' 18A-18D. The plurality of fields include a starting physical address 18A, a universal unique identifier (UUID) 18B, a size of the device 18C and a number of blocks 18D that are used to store information for a file system executed by a computing device. It is noteworthy that the metadata structure 16A-16N may have fewer or more fields than 18A-18D. The adaptive aspects disclosed herein are not limited to any specific number of fields in the metadata structure.

The array 12 enables a file system to easily add or remove storage devices from a computing device. For example, FIG. 1B shows three storage devices D0 1 GB, D1 2 GB and D2 4 GB. Array 12 has 7 entries where E0 points to D0 (metadata structure 16A), while E1, and E2 point to D1 (metadata structure 16B) and E3-E6 point to D2 (metadata structure 16C). If a fourth device, D3 of 1 GB capacity is added, as shown in FIG. 1C, then the array 12 is updated such that the number of entries in array 12 increases to 8. As an example, E0 points to D0 16A, E1/E2 point to D1 16B, E3-E6 point to D2 16C, while E7 points to D3 16D. This enables a computing system to use the storage space of the new device D3 with Do, D1 and D2.

FIG. 1D shows another example of array 12 with 15 entries, when the 4^{th} storage device D3′ has a storage capacity of 0.5 GB. In this example, E0-E1 point to D0 16A, E2-E5 point to D1 16B, E6-E13 point to D2 16C and E14 points to D3′ 16E. Therefore, regardless of the storage capacity, array 12 is efficiently updated to accommodate a new storage device to a system that is already using storage devices (D0, D1 and D2).

It is noteworthy that FIGS. 1C-1D show examples of adding devices of different storage capacities. The examples are meant to illustrate how array 12 can be dynamically updated for using a new storage device in an existing system. The adaptive aspects are not limited to any specific number of devices or storage capacity. Furthermore, although the examples show addition of a new device, array 12 can be easily updated when a storage device is removed.

The system of FIG. 1A enables a file system to dynamically add or remove one or more devices at mount time by recalculating or updating array 12. The logical address of each block can be translated to a physical address by: Device_Mapping_Array [LA/GCD]+[mod LA % GCD], where LA is the logical address, GCD is the greatest common denominator of storage capacity size.

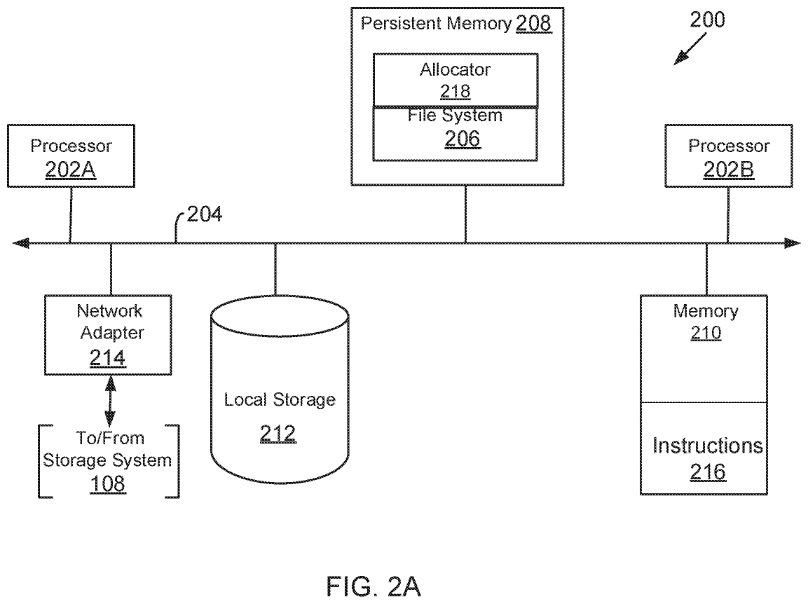

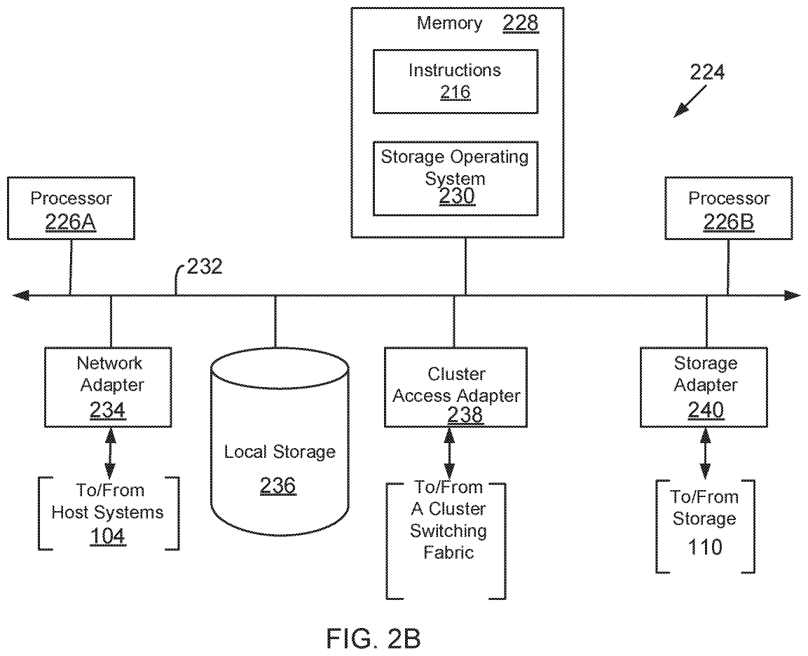

In one aspect, the technology disclosed herein enables a file system to efficiently allocate storage space. In addition to array 12 for logical to physical address translation, the system uses an allocator address space for allocating store space. The allocator address space may be managed by an allocator [e.g. 218, FIG. 2B] that may be part of a file system or a component that interfaces with the file system.

In one aspect, the allocator address space is comprised of a plurality of “chunks” (or units, used interchangeably throughout this specification), where each unit may be of a specific size (e.g. 2 MB). Each unit is represented within an allocator structure and is assigned to a queue. As an example, the file system may maintain a queue per processor of a computing device. Any unit that is not full is assigned to a queue using, for example, a weighted round robin technique or any other technique for uniformly distributing allocator units across multiple devices, as described below in detail.

FIG. 1E shows an example of using an allocator address space 20 and a logical address space 21, according to one aspect of the present disclosure. The logical address space 21 includes a logical address for each storage device. For example, a logical block address (LBA) for storage device D0 is shown as D0A0, D0An−1 and so forth. Logical block addressing is a linear addressing scheme, were blocks are located by an integer index, with the first block being LBA 0, the second LBA 1, and so on. The logical blocks of structure 21 are associated with a unit/chunk from the allocator address space 20.

In one aspect, when a file system mounts, the free units from the allocator address space 20 may be assigned to different queues maintained by a file system. For example, as show in FIG. 1E, the ile system maintains queue Q0 22A to Qn−1 22N, associated with different processors. The queue Q0 22A is maintained for processor P0 26A, queue Q1 22B is maintained for processor P1 26B and queue Qn−1 22N is maintained for processor Pn−1 26N. It is noteworthy that any processor can access any queue using locks. Each queue is calculated a unit from the allocator address space 20 based on whether the unit is available to store data. The free units of the allocator address space can be distributed in a round robin fashion such that each queue is assigned a unit from different devices, based on the storage capacity of the storage devices. For example, D0C0 is a first unit for device D0 associated with D0A0, while D1C0 is a first unit from device D1. The units from the allocator address space 20 may be distributed as follows:

Q0 22A: D0C0, D1C0, D2C0 . . . Dk−1C0, D0Cn, D1Cn, D2Cn . . . Dk−1Cn . . . .

Q1 22B: D0C0, D1C1, D2C1 . . . Dk−1C1, D0Cn+1, D1Cn+1, D2Cn+1 . . . Dk−1Cn+1 . . . .

Qn−1 22N: D0Cn−1, D1Cn−1, D2Cn−1, Dk−1Cn−1 . . . D0C2n−1, D1C2n−1, D2C2n−1 . . . Dk−1C2n−1 . . . .

FIG. 1F shows an example of allocating units from the allocator address space 20 for three storage devices D0 (1 GB), D1 (2 GB) and D2 (4 GB). For a single processor, Q0 22A the units may be assigned as following:

Q0=D0C0, D1C0, D2C0 . . . Dk−1C0, D0C, D1C1, D2C1 . . . Dk−1C1 . . . D0C2n−1, D1C2n−1, D2C2n−1 . . . Dk−1C2n−1 . . . .

As shown above, storage space across storage devices is allocated and managed in an efficient manner. The allocation may be executed when a file system mounts as well when a storage device is added or removed. The file system maintains a data structure that tracks used blocks and free blocks. When a device is added/removed, array 12 is recalculated and the storage space available from the new device and the previously existing devices is assigned using the allocator address space 20, as described below in detail.

Process Flows:

FIG. 1G shows a process 30 executed by a processor executing instructions out of a memory, according to one aspect of the present disclosure. Process 30 begins in block B32, when a computing device with one or more storage devices and a file system is initialized for execution. The file system may be a PM based file system or any other type, as described below in detail.

In block B34, a logical, linear address space (e.g. using array 21, FIG. 1E) is assigned for each of a plurality of storage devices. In block B36, a number of entries are determined for array 12. As an example, the number of entries are based on the total size of all the storage devices divided by a greatest common denominator of the size of storage devices, as described above. This limits the number of entries in array 12 and hence is efficient.

In block B38, as an example, each entry points to a metadata structure 16A-16N. The metadata structure may include a starting physical address of each storage device. This enables converting a logical address to a physical address, as described above. In another aspect, the entry may point directly to a physical address of each storage device.

A chunk or unit size for an allocator address space 20 is defined in block B40. For example, the chunk size may be 2 MB or any other size.

In block B42, one or more queues associated with one or more processors are initialized. The queues are assigned units from the allocator address space 20 as described above with respect to FIGS. 1E and 1F. The assigned units are used by the processors to store data.

FIG. 1H shows a process 50 for allocating storage space using array 12, logical address space 21 and the allocator address space 20, according to one aspect of the present disclosure. The process may begin in block B52 when a file system is mounted. The term “mount” means that an operating system of a computing device makes the file system available for use. It is noteworthy that process 50 may be executed at any time and is not limited to file system “mount time” i.e. when the file system is mounted.

In block B54, array 12 is built or updated as described above with respect to FIG. 1G. Array 12 is updated when a storage device is added or removed.

In block B56, the file system metadata is evaluated to identify units of the allocator address space 20 for free space. The file system metadata is maintained by the file system to track which units are free and which cannot be used for storing data. This evaluation may be executed any time including for every mount operation of the file system.

In block B58, the process iterates through each unit of the allocator address space 20 and allocates the free space to one or more queues as shown in FIGS. 1E and 1F, and described above.

In one aspect, systems and processes described herein enable a computing device to optimize storage space usage by efficiently using the array 12, logical address space 20 and the allocator address space 20. Storage space for devices that are added or removed can be rapidly allocated, for example, for each file system mount operation or any other time. In another aspect, storage space from new storage devices can be allocated efficiently in computing systems with existing storage devices. The newly allocated space can be used by any resource of the computing systems. This approach is more flexible than the rigid striping techniques used in traditional RAID technology.

In one aspect, methods and systems for a storage system are provided. One method includes updating a device mapping array upon addition of a second storage device for a computing system having at least a first storage device for storing information. The device mapping array includes a plurality of entries, each entry pointing to a starting address of the first and the second storage device; and a number of the plurality of entries are based on a total storage capacity of the first and the second storage device. The method further includes mapping free blocks of a logical address space for the first and second storage device to a plurality of units of an allocator address space; and assigning the mapped plurality of units of the allocator address space to a queue associated with a processor of the computing system. For storing information, the device mapping array provides logical to physical address translation and the mapped units of the queue uniformly use available storage space of the first and second storage devices.

System 100:

FIG. 1I shows an example of a networked storage operating environment 100 (also referred to as system 100), for implementing the various adaptive aspects of the present disclosure described above with respect to FIGS. 1A-1H. In one aspect, system 100 may include a plurality of computing systems 104A-104N (may also be referred to and shown as server system (or server systems) 104 or as host system (or host systems) 104) that may access one or more storage systems 108 via a connection system 116 such as a local area network (LAN), wide area network (WAN), the Internet and others. The server systems 104 may communicate with each other via connection system 116, for example, for working collectively to provide data-access service to user consoles (or computing devices) 102A-102N (may be referred to as user 102 or client system 102). It is noteworthy that a host system may execute a persistent-memory (PM) based file system, described below in detail with respect to FIG. 2B.

Server systems 104 may be computing devices configured to execute applications 106A-106N (may be referred to as application 106 or applications 106) over a variety of operating systems, including the UNIX®, Microsoft Windows®, and Linux® based operating systems. Applications 106 may utilize data services of storage system 108 to access, store, and manage data in a set of storage devices 110 that are described below in detail. Applications 106 may include a database program, an email program or any other computer executable program.

Server systems 104 generally utilize file-based access protocols when accessing information (in the form of files and directories) over a network attached storage (NAS)-based network. Alternatively, server systems 104 may use block-based access protocols, for example, the Small Computer Systems Interface (SCSI) protocol encapsulated over TCP (iSCSI) and SCSI encapsulated over Fibre Channel (FCP) to access storage via a storage area network (SAN). Furthermore, the server systems 104 may utilize a PM based file system that uses persistent memory for storing data.

In one aspect, server 104A executes a virtual machine environment 114, according to one aspect. In the virtual machine environment 114, a physical resource is time-shared among a plurality of independently operating processor executable virtual machines (VMs). Each VM may function as a self-contained platform, running its own operating system (OS) and computer executable, application software. The computer executable instructions running in a VM may be collectively referred to herein as “guest software”. In addition, resources available within the VM may be referred to herein as “guest resources”.

The guest software expects to operate as if it were running on a dedicated computer rather than in a VM. That is, the guest software expects to control various events and have access to hardware resources on a physical computing system (may also be referred to as a host platform) which may be referred to herein as “host hardware resources”. The host hardware resource may include one or more processors, resources resident on the processors (e.g., control registers, caches and others), memory (instructions residing in memory, e.g., descriptor tables), and other resources (e.g., input/output devices, host attached storage, network attached storage or other like storage) that reside in a physical machine or are coupled to the host platform.

The virtual machine environment 114 includes a plurality of VMs 120A-120N that execute a plurality of guest OS 122A-122N (may also be referred to as guest OS 122) to share hardware resources 128. As described above, hardware resources 128 may include CPU, memory, I/O devices, storage or any other hardware resource. A VM may also execute a PM based file system executing the process blocks of FIGS. 1G and 1H described above in detail.

A virtual machine monitor (VMM) 124, for example, a processor executed hypervisor layer provided by VMWare Inc., Hyper-V layer provided by Microsoft Corporation (without derogation of any third party trademark rights) or any other virtualization layer type, presents and manages the plurality of guest OS 122. VMM 124 may include or interface with a virtualization layer (VIL) 126 that provides one or more virtualized hardware resource 128 to each guest OS. For example, VIL 126 presents physical storage at storage devices 110 as virtual storage (for example, as a virtual hard drive (VHD)) to VMs 120A-120N.

In one aspect, VMM 124 is executed by server system 104A with VMs 120A-120N. In another aspect, VMM 124 may be executed by a separate stand-alone computing system, often referred to as a hypervisor server or VMM server and VMs 120A-120N are presented via another computer system. It is noteworthy that various vendors provide virtualization environments, for example, VMware Corporation, Microsoft Corporation (without derogation of any third party trademark rights) and others. The generic virtualization environment described above with respect to FIG. 1I may be customized depending on the virtual environment provider.

System 100 may also include the management system 118 executing a management application 130 for managing and configuring various elements of system 100.

In one aspect, storage system 108 is a shared storage system having access to a set of mass storage devices 110 (may be referred to as storage devices 110) within a storage subsystem 112. As an example, storage devices 110 may be a part of a storage array within the storage sub-system 112. Storage devices 110 are used by the storage system 108 for storing information. The storage devices 110 may include writable storage device media such as magnetic disks, video tape, optical, DVD, magnetic tape, non-volatile memory devices for example, self-encrypting drives, flash memory devices and any other similar media adapted to store information. The storage devices 110 may also be organized as one or more groups of Redundant Array of Independent (or Inexpensive) Disks (RAID). The various aspects disclosed herein are not limited to any particular storage device or storage device configuration. The storage system 108 allocates storage space at the storage devices 110 using the techniques and systems described above with respect to FIGS. 1A-1H.

In one aspect, to facilitate access to storage devices 110, a storage operating system of storage system 108 “virtualizes” the storage space provided by storage devices 110. The storage system 108 can present or export data stored at storage devices 110 to server systems 104 and VMM 124 as a storage volume or one or more qtree sub-volume units including logical unit numbers (LUNs). Each storage volume may be configured to store data files (or data containers or data objects), scripts, word processing documents, executable programs, and any other type of structured or unstructured data. From the perspective of the VMS/server systems, each volume can appear to be a single disk drive. However, each volume can represent the storage space in one disk, an aggregate of some or all of the storage space in multiple disks, a RAID group, or any other suitable set of storage space.

It is noteworthy that the term “disk” as used herein is intended to mean any storage device/space and not to limit the adaptive aspects to any particular type of storage device, for example, hard disks.

The storage system 108 may be used to store and manage information at storage devices 110 based on a request generated by server system 104, management system 118, user 102 and/or a VM. The request may be based on file-based access protocols, for example, the CIFS or the NFS protocol, over TCP/IP. Alternatively, the request may use block-based access protocols, for example, iSCSI or FCP.

As an example, in a typical mode of operation, server system 104 (or VMs 120A-120N) transmits one or more input/output (I/O) commands, such as an NFS or CIFS request, over connection system 116 to the storage system 108. Storage system 108 receives the request, issues one or more I/O commands to storage devices 110 to read or write the data on behalf of the server system 104, and issues an NFS or CIFS response containing the requested data over the connection system 116 to the respective server system 104.

In one aspect, storage system 108 may have a distributed architecture, for example, a cluster based system that may include a separate network module and a storage module. Briefly, the network module is used to communicate with server systems 104 and management system 118, while the storage module is used to communicate with the storage devices 110.

Computing System 200:

FIG. 2A is a block diagram of a computing system 200 executing a file system 206 out of a persistent memory (PM) 208, according to one aspect of the present disclosure. Allocator 218 is shown as a separate block for managing the allocator address space 20 for convenience. The allocator 218 may be integrated with the PM based file system 206. In one aspect, file system 206/allocator 218 may be integrated with MAXDATA (memory accelerated data) software provided by NetApp Inc. the assignee of the present application (without derogation of any trademark rights). The adaptive aspects of the present disclosure are not limited to any specific software or software configuration.

The PM 208 is a byte addressable memory device that is used by the file system 206 to directly access stored data units. The file system 206 uses the logical address space 21, the allocator address space 24 and the array 12, as described above. The file system 206/allocator 208 execute the process blocks of FIGS. 1G and 1H for allocating storage space at PM 208.

System 200 may also include a plurality of processors 202A and 202B, a memory 210, a network adapter 214, and a local storage device 212 interconnected by a bus system 204. The local storage 212 comprises one or more storage devices, such as disks, SSDs and any other storage device type utilized by the processors to store information, in addition to the information tiered at PM 208.

The bus system 204, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

System 200 is illustratively embodied as a dual processor storage system executing the file system 206, to logically organize information as a hierarchical structure of named directories, files and special types of files called virtual disks (hereinafter generally “blocks”) using PM 208. It is noteworthy that the system 200 may alternatively comprise a single or more than two processor systems.

The processors 202A/202B operate as central processing units (CPUs) of computing system 200 and, thus, control its overall operation. In certain aspects, the processors 202A/202B accomplish this by executing programmable instructions stored in memory 210, shown separately from PM 208 only for clarity. The processors 202A/202B may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 210 represents any form of random access memory (RAM), read-only memory (ROM), flash memory, or the like, or a combination of such devices. Memory 210 includes the main memory of system 200. Instructions 216 which implements techniques introduced above may reside in and may be executed (by processors 202A/202B) out of memory 210. For example, instructions 216 may include code used for executing the process blocks of FIGS. 1G and 1H.

The memory 210 also comprises storage locations that are addressable by the processors 202A/202B for storing programmable instructions and data structures. The processors 202A/202B may, in turn, comprise processing elements and/or logic circuitry configured to execute the programmable instructions and manipulate the data structures. It will be apparent to those skilled in the art that other processing and memory means, including various computer readable media, may be used for storing and executing program instructions described herein.

The network adapter 214 comprises a plurality of ports adapted to couple the system 200 to one or more server systems over point-to-point links, wide area networks, virtual private networks implemented over a public network (Internet) or a shared local area network. The network adapter 214 thus may comprise the mechanical, electrical and signaling circuitry needed to connect system 200 to the storage system 108. In one aspect, data stored at PM 208 may be tiered to storage system 108 via the network adapter 214. Illustratively, the computer network may be embodied as an Ethernet network, a Fibre Channel (FC) network or any other network type.

Storage System Node 224:

FIG. 2B is a block diagram of a computing system 224 executing a storage operating system 230 for storage system 108, according to one aspect of the present disclosure. System 224 may be used by a stand-alone storage system 108, or a storage system node operating within a cluster based storage system that includes a network module for network functions and a storage module for storage functions.

System 224 may include a plurality of processors 226A and 226B, a memory 228, a network adapter 234, a cluster access adapter 238 (used for a networked cluster environment), a storage adapter 240 and local storage 236 interconnected by a system bus 232. The local storage 236 comprises one or more storage devices, such as disks, utilized by the processors to locally store configuration and other information.

The bus system 232, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The cluster access adapter 238 comprises a plurality of ports adapted to couple system 224 to other nodes of a cluster. In the illustrative aspect, Ethernet may be used as the clustering protocol and interconnect media, although it will be apparent to those skilled in the art that other types of protocols and interconnects may be utilized within the cluster architecture described herein.

As an example, system 224 is illustratively embodied as a dual processor storage system executing the storage operating system 230 that preferably implements a high-level module, such as a file system, to execute the process blocks of FIGS. 1G and 1H as well as logically organize information as a hierarchical structure of named directories, files and special types of files called virtual disks (hereinafter generally “blocks”) on storage devices 110. However, it will be apparent to those of ordinary skill in the art that the system 224 may alternatively comprise a single or more than two processor systems. Illustratively, one processor 226 executes the functions of a network module on a node, while the other processor 226B executes the functions of a storage module.

The processors 226A/226B operate as central processing units (CPUs) of computing system 224 and, thus, control its overall operation. In certain aspects, the processors 226A/226B accomplish this by executing programmable instructions stored in memory 228. The processors 226A/226B may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 228 represents any form of random access memory (RAM), read-only memory (ROM), flash memory, or the like, or a combination of such devices. Memory 228 includes the main memory of system 200. Instructions 216 which implements techniques introduced above may reside in and may be executed (by processors 226A/226B) out of memory 228. For example, instructions 216 may include code used for executing the process blocks of FIGS. 1G and 1H.

In one aspect, memory 228 illustratively comprises storage locations that are addressable by the processors and adapters for storing programmable instructions and data structures. The processor and adapters may, in turn, comprise processing elements and/or logic circuitry configured to execute the programmable instructions and manipulate the data structures. It will be apparent to those skilled in the art that other processing and memory means, including various computer readable media, may be used for storing and executing program instructions described herein.

The storage operating system 230, portions of which is typically resident in memory 228 and executed by the processing elements, functionally organizes the system 224 by, inter alia, invoking storage operations in support of the storage service provided by storage system 108. An example of operating system 230 is the DATA ONTAP® (Registered trademark of NetApp, Inc. operating system available from NetApp, Inc. that implements a Write Anywhere File Layout (WAFL® (Registered trademark of NetApp, Inc.)) file system. However, it is expressly contemplated that any appropriate storage operating system may be enhanced for use in accordance with the inventive principles described herein. As such, where the term “ONTAP” is employed, it should be taken broadly to refer to any storage operating system that is otherwise adaptable to the teachings of this invention.

The network adapter 234 comprises a plurality of ports adapted to couple the system 224 to one or more server systems over point-to-point links, wide area networks, virtual private networks implemented over a public network (Internet) or a shared local area network. The network adapter 234 thus may comprise the mechanical, electrical and signaling circuitry needed to connect storage system 108 to the network. Illustratively, the computer network may be embodied as an Ethernet network or a FC network.

The storage adapter 240 cooperates with the storage operating system 230 executing on the system 224 to access information requested by the server systems 104 and management system 118. The information may be stored on any type of attached array of writable storage device media such as video tape, optical, DVD, magnetic tape, bubble memory, electronic random access memory, flash memory devices, micro-electro mechanical and any other similar media adapted to store information, including data and parity information.

The storage adapter 240 comprises a plurality of ports having input/output (I/O) interface circuitry that couples to the disks over an I/O interconnect arrangement, such as a conventional high-performance, FC link topology.

In another aspect, instead of using a separate network and storage adapter, a converged adapter is used to process both network and storage traffic.

Storage Operating System 230:

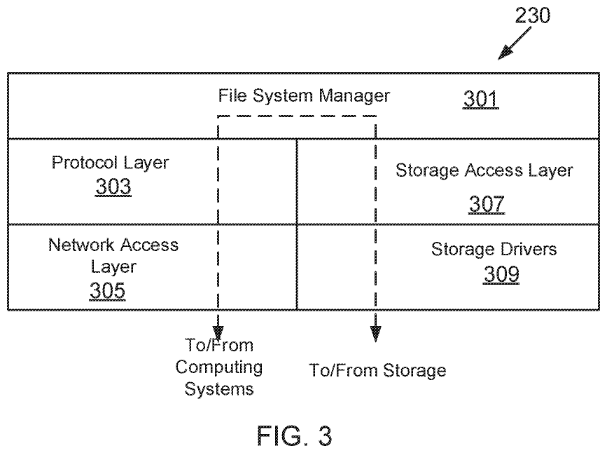

FIG. 3 illustrates a generic example of operating system 230 executed by storage system 108, according to one aspect of the present disclosure. As an example, storage operating system 230 may include several modules, or “layers”. These layers include a file system manager 303 that keeps track of a directory structure (hierarchy) of the data stored in storage devices and manages read/write operations, i.e. executes read/write operations on disks in response to server system 104 requests. The file system manager 303 generates array 12 and maintains the logical address space 21 and the allocator address space 20. The file system manager 303 also includes an allocator component (e.g. 218, FIG. 2A) that maintains the allocator address space units and the various queues described above with respect to FIGS. 1E and 1F.

Operating system 230 may also include a protocol layer 303 and an associated network access layer 305, to allow system 200 to communicate over a network with other systems, such as server system 104 and management system 118. Protocol layer 303 may implement one or more of various higher-level network protocols, such as NFS, CIFS, Hypertext Transfer Protocol (HTTP), TCP/IP and others, as described below.

Network access layer 305 may include one or more drivers, which implement one or more lower-level protocols to communicate over the network, such as Ethernet. Interactions between server systems 104 and mass storage devices 110 are illustrated schematically as a path, which illustrates the flow of data through the storage operating system 230.

The storage operating system 230 may also include a storage access layer 307 and an associated storage driver layer 309 to communicate with a storage device. The storage access layer 307 may implement a higher-level disk storage protocol, such as RAID (redundant array of inexpensive disks), while the storage driver layer 309 may implement a lower-level storage device access protocol, such as FC or SCSI.

It should be noted that the software “path” through the operating system layers described above needed to perform data storage access for a client request may alternatively be implemented in hardware. That is, in an alternate aspect of the disclosure, the storage access request data path may be implemented as logic circuitry embodied within a field programmable gate array (FPGA) or an ASIC. This type of hardware implementation increases the performance of the file service provided by storage system 108.

As used herein, the term “storage operating system” generally refers to the computer-executable code operable on a computer to perform a storage function that manages data access and may implement data access semantics of a general purpose operating system. The storage operating system can also be implemented as a microkernel, an application program operating over a general-purpose operating system, such as UNIX® or Windows®, or as a general-purpose operating system with configurable functionality, which is configured for storage applications as described herein.

In addition, it will be understood to those skilled in the art that the invention described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a disk assembly directly-attached to a client or host computer. The term “storage system” should therefore be taken broadly to include such arrangements in addition to any subsystems configured to perform a storage function and associated with other equipment or systems.

The system and techniques described herein are applicable and useful in the cloud computing environment. Cloud computing means computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. The term “cloud” is intended to refer to the Internet and cloud computing allows shared resources, for example, software and information to be available, on-demand, like a public utility.

Typical cloud computing providers deliver common business applications online which are accessed from another web service or software like a web browser, while the software and data are stored remotely on servers. The cloud computing architecture uses a layered approach for providing application services. A first layer is an application layer that is executed at client computers. In this disclosure, the application allows a client to access storage via a cloud.

After the application layer, is a cloud platform and cloud infrastructure, followed by a “server” layer that includes hardware and computer software designed for cloud specific services. Details regarding these layers are not germane to the inventive aspects.

Thus, methods and systems for managing storage space in storage devices have been described. Note that references throughout this specification to “one aspect” or “an aspect” mean that a particular feature, structure or characteristic described in connection with the aspect is included in at least one aspect of the present invention. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the present disclosure, as will be recognized by those of ordinary skill in the art.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

1. A method, comprising;
dynamically generating a plurality of entries of a device mapping array, upon making a second storage device available to a computing system having a first storage device for storing information,
where a number of the plurality of entries is based on a total storage capacity of the first and the second storage device;
associating the plurality of entries to a metadata structure corresponding to the first and second storage device, the metadata structure storing a starting physical address of the first and the second storage device;
identifying a plurality of free units of an allocator address space;
mapping the plurality of free units to logical blocks of a logical address space of the first and second storage device;
assigning the mapped plurality of units of the allocator address space to a queue associated with a processor of the computing system; and
uniformly using storage space of the first and second storage device for storing information by utilizing the metadata structure for logical to physical address translation and one or more of the assigned mapped units.

2. The method of claim 1, wherein the number of plurality of entries is based on the total storage capacity and a greatest common denominator of storage capacity of the first and the second storage device.

3. The method of claim 1, further comprising: updating the device mapping array for a mount operation of a file system of the computing system.

4. The method of claim 1, further comprising: dynamically updating the device mapping array when any storage device is added or removed from the computing system.

5. The method of claim 3, wherein the file system is a persistent memory based file system.

6. The method of claim 1, wherein the starting address is a physical starting address for the first storage device and the second storage device.

7. The method of claim 1, further comprising: wherein when the computing system uses multiple processors, the file system maintaining a queue for each processor, and the queue for each processor is assigned mapped units from the allocator address space for storing information.

8. A non-transitory machine readable storage medium having stored thereon instructions for performing a method, comprising machine executable code which when executed by at least one machine, causes the machine to:
dynamically generate a plurality of entries of a device mapping array, upon making a second storage device available to a computing system having a first storage device for storing information, where a number of the plurality of entries is based on a total storage capacity of the first and the second storage device;
associate the plurality of entries to a metadata structure corresponding to the first and second storage device, the metadata structure storing a starting physical address of the first and the second storage device;
identify a plurality of free units of an allocator address space;
map the plurality of free units to logical blocks of a logical address space of the first and second storage device;
assign the mapped plurality of units of the allocator address space to a queue associated with a processor of the computing system; and
utilize the metadata structure for logical to physical address translation and one or more of the assigned mapped units to store information.

9. The storage medium of claim 8, wherein the number of plurality of entries is based on the total storage capacity and a greatest common denominator of storage capacity of the first and the second storage device.

10. The storage medium of claim 8, wherein the device mapping array is updated upon a mount operation of a file system of the computing system.

11. The storage medium of claim 8, wherein the device mapping array is updated when any storage device is added or removed from the computing system.

12. The storage medium of claim 10, wherein the file system is a persistent memory based file system.

13. The storage medium of claim 8, wherein the starting address is a physical starting address for the first storage device and the second storage device.

14. The storage medium of claim 8, wherein when the computing system uses multiple processors, the file system maintains a queue for each processor, and the queue for each processor is assigned mapped units from the allocator address space for storing information.

15. A system comprising:
a memory containing machine readable medium comprising machine executable code having stored thereon instructions; and a processor module coupled to the memory to execute the machine executable code to:
dynamically generate a plurality of entries of a device mapping array upon making a second storage device available to a computing system having a first storage device for storing information, where a number of the plurality of entries is based on a total storage capacity of the first and the second storage device;
associate the plurality of entries to a metadata structure corresponding to the first and second storage device, the metadata structure storing a starting physical address of the first and the second storage device;
identify a plurality of free units of an allocator address space;
map the plurality of free units to logical blocks of a logical address space of the first and second storage device;
assign the mapped plurality of units of the allocator address space to a queue associated with a processor of the computing system; and
utilize the metadata structure for logical to physical address translation and one or more of the assigned mapped units to store information.

16. The system of claim 15, wherein the number of plurality of entries is based on the total storage capacity and a greatest common denominator of storage capacity of the first and the second storage device.

17. The system of claim 15, wherein the device mapping array is updated upon a mount operation of a file system of the computing system.

18. The system of claim 15, wherein the device mapping array is updated when any storage device is added or removed from the computing system.

19. The system of claim 17, wherein the file system is a persistent memory based file system.

20. The system of claim 15, wherein the starting address is a physical starting address for the first storage device and the second storage device.
